(19) United States
(12) Patent Application Publication
(10) Pub. No.: US 2014/0149650 A1
(43) Pub. Date: May 29, 2014

(54) Caching Program Optimization

(71) Applicant: Jason Caulkins, Issaquah, WA (US)

(72) Inventor: Jason Caulkins, Issaquah, WA (US)

(21) Appl. No.: 13/688,495

(22) Filed: Nov. 29, 2012

(51) Int. Cl. G06F 12/08

(52) U.S. Cl. CPC G06F 12/0804
USPC 711/104

(57) ABSTRACT

A method for optimizing performance of programs has steps for scanning storage mechanisms of the computing appliance by executing a configuration utility by a Central Processing Unit (CPU) of the computing appliance to find and identify installed programs, comparing the determined installed programs to a database (dB) of information and files prepared to optimize performance of specific programs through caching, and determining matches between the installed programs and specific programs having information and files in the dB, selecting installed programs to optimize for performance, partitioning a portion of system RAM of the computing appliance as cache, and loading information and files from local storage mechanisms for each program selected to the cache partitioned in system RAM, enabling the programs selected to at least read data in operation from the cache portion partitioned in system RAM.

### CROSS-REFERENCE TO RELATED APPLICATIONS

N/A

### BACKGROUND OF THE INVENTION

1. Field of the Invention

The present invention is in the field of general purpose computers, and pertains particularly to caching in program execution.

2. Description of Related Art

Computer systems typically have data storage systems from which data is read and to which data is written during program execution. Permanent storage is typically on a disk drive or other persistent media. Computers also typically have Random Access Memory (RAM), which is volatile memory, meaning that the contents are lost when power is switched off. It is well-known that read and write is generally slower with persistent media than with RAM. Because of this, computers in the art are often enabled, once a program is operating, to temporarily hold some data in RAM for quicker access by the central processing unit (CPU). This process is termed caching in the art.

For optimal performance, computer programs and applications need to access most urgent and frequently used data as quickly as possible which the system will ‘learn’ to cache making that data more readily available. Still, the learning takes time, and does not always produce the optimum performance. Therefore what is needed is a method to enable the user of the computer to configure individual programs to cache data in a manner to optimize performance for those programs.

### BRIEF SUMMARY OF THE INVENTION

In one embodiment of the invention a method for optimizing performance of programs installed on a computing appliance is provided, comprising steps of (a) scanning storage mechanisms of the computing appliance by executing a configuration utility by a Central Processing Unit (CPU) of the computing appliance to find and identify installed programs, (b) comparing the determined installed programs to a database (dB) of information and files prepared to optimize performance of specific programs through caching, and determining matches between the installed programs and specific programs having information and files in the dB, (c) among the matches found in step (b), selecting installed programs to optimize for performance, (d) partitioning a portion of system RAM of the computing appliance as cache, and (e) loading information and files from local storage mechanisms for each program selected in step (c) to the cache partitioned in system RAM, enabling the programs selected in step (c) to at least read data in operation from the cache portion partitioned in system RAM.

In one embodiment the dB is referenced over the Internet network from an Internet connected server. Also in one embodiment the configuration utility and the dB are loaded to the computing appliance and referenced locally.

In some embodiments, for program matches from step (b), in step (c) a user is presented an interactive interface with interactive indicia to configure the computing appliance for optimization of matching programs.

In another aspect of the invention a system for optimizing performance of programs installed on a computing appliance is provided, comprising a configuration utility executable on a CPU of the computing appliance from a non-transitory storage medium, and a dB comprising information and files associated with programs, the information and files useful with cache operations to optimize performance of the programs. The configuration utility, executing on the CPU scans storage mechanisms of the computing appliance to find and identify installed programs, compares the determined installed programs to the database (dB) of information and files, and determines matches between the installed programs and specific programs having information and files in the dB, presents the matches to a user to select installed programs to optimize for performance, partitions a portion of system RAM of the computing appliance as cache, and loads information and files from the local storage mechanisms for each program selected to the cache partitioned in system RAM, enabling the programs selected to at least read data in operation from the cache portion partitioned in system RAM.

In one embodiment of the system the dB is referenced over the Internet network from an Internet connected server. Also in one embodiment the configuration utility and the dB are loaded to the computing appliance and referenced locally. In some embodiments for program matches a user is presented an interactive interface with interactive indicia to configure the computing appliance for optimization of matching programs.

In another aspect an internet connected server is provided, comprising software executing from a non-transitory medium, a configuration utility executable on a CPU of a computing appliance, and a stored dB comprising information and files associated with programs prepared to optimize performance of specific programs in caching operation. The server provides an interactive interface to a browser executing on an Internet connected computing appliance, the interactive interface enabling a user to download the dB and the configuration utility, to be executed on the CPU of the computing appliance, identifying programs installed on the computing appliance that may be optimized by information and files from the dB, partitioning a portion of system RAM of the computing appliance as cache, and loading information and files from the local storage mechanisms to the cache portion of system RAM, optimizing performance of the programs identified on the computing appliance.

### BRIEF DESCRIPTION OF THE SEVERAL VIEWS OF THE DRAWINGS

FIG. 1 is an architectural overview of a network that supports download and utilization of software which optimizes applications and operating systems according to an embodiment of the present invention.

FIG. 2 is an architectural illustration of a computer system utilizing application and operating system optimization software according to an embodiment of the present invention.

FIG. 3 is a process flow chart illustrating steps for configuring an optimization of an application or operating system according to an embodiment of the present invention.

FIG. 4 is an exemplary screen shot of a scan inquiry according to an embodiment of the present invention.

FIG. 5 is an exemplary screen shot of a cache enquiry interface according to an embodiment of the present invention.

FIG. 6 is an exemplary screen shot of optimization inquiries interface according to an embodiment of the present invention.

### DETAILED DESCRIPTION OF THE INVENTION

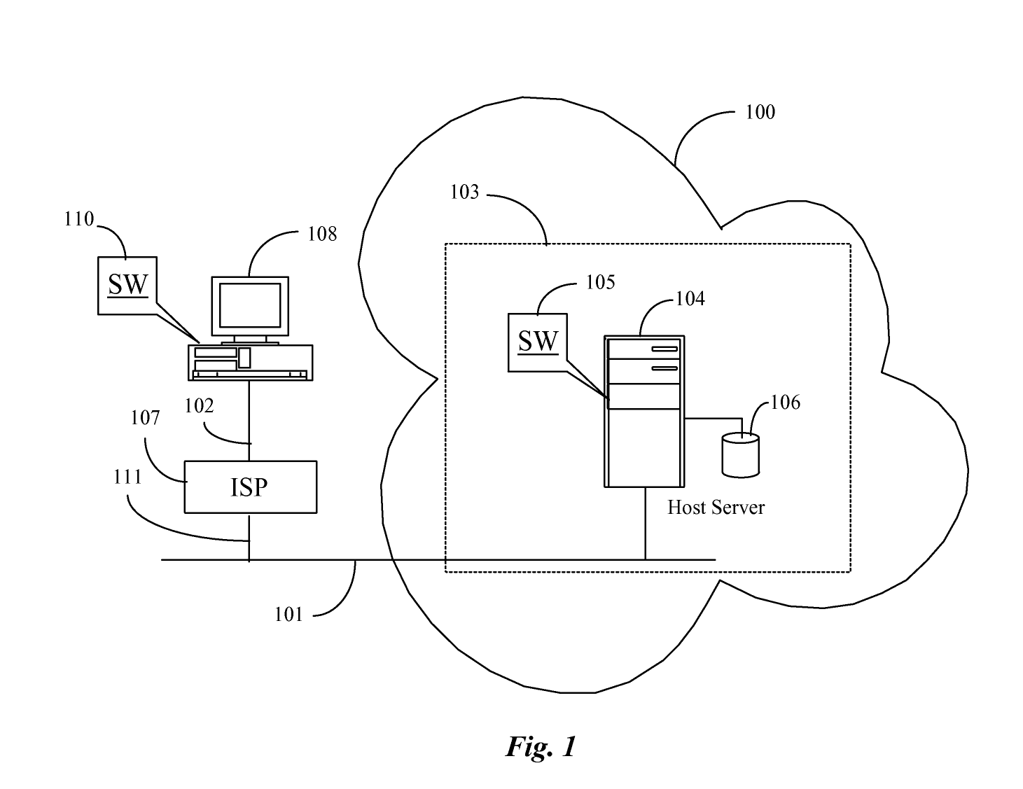

FIG. 1 is an architectural overview of a network 100 that facilitates download and utilization of software which optimizes applications and operating systems loaded on to a computer system 108. Network 100 is the Internet network in this example, however other media may be used to facilitate loading and utilization of application and operating system optimization software without departing from the spirit and scope of the invention. The inventor chooses network 100, which may also be referred to herein as Internet 100, because of its wide spread use in delivering and utilizing software. It is to be noted herein that applications and operating systems loaded onto a computer system are not the only applications and operating systems that may be optimized by operation of the present invention. For example cloud based applications and operating systems may be optimized by operation of the present invention and therefore the example of applications and operating systems loaded into a computer system provided in this specification should not be construed as a limitation to practicing the invention.

In embodiments of the invention a unique optimization service is provided via the Internet optimizing software installed on computer system 108. The service in various embodiments is represented logically by hardware and software, more specifically by a host server (HS) 104 executing software (SW) 105, and an independently maintained database (dB) 106. Database 106 has been developed by the inventor to include optimization information, such as files and parameters, specific to many commercially available programs and operating systems, which may be applied to optimize operation of those programs and operating systems. A service provider 103 having access to network 100 provides the service. The service may operate in any one of several ways. For example, a user may download all necessary components, including the dB, and execute the service entirely on computer 108 executing SW 110, or install SW 110 from a disk or other mobile storage. The system may also be operated in cooperation with server 104 over the Internet network.

Internet 100 is further illustrated by an Internet backbone 101 which represents all of the lines, equipment and access points and sub-networks making up the Internet network as a whole. Therefore there are no geographic limits to the practice of the present invention.

HS 104 is provided by and maintained by service provider 103 and has Internet connectivity through backbone 101. Other servers and applications not illustrated may also be provided as required such as a database update application and financial transactions software and the like.

Optimizing program operation is desirable for many reasons including, but not limited to, obtaining a competitive advantage in marketing and selling such applications and operating systems. One element in optimizing the applications and operating systems is to quicken the retrieval of some of the most urgently needed and the more frequently accessed data and information these applications and operating systems commonly use. Various methods exist for tracking this data to be accessed. Caching is a well understood and widely applied technique in modern computer storage systems designed to facilitate faster accessing of data and information that certain applications and operating systems require more frequently and urgently. General caching may occur when data access patterns inculcate caching within a particular computer system. This undesirably takes time to manifest and also may cause undesired caching of data consuming cache space that a user may wish to use for caching of other data. These are some problems the present invention is meant to address.

In one embodiment of the invention a software program has been developed to scan and detect applications and operating systems programmed into a computer system, to compare the detected applications and operating systems to a proprietary database of information and configuration parameters associated with applications and operating systems which are known to benefit from caching, that is, will enhance the efficacy of the applications and operating systems by making frequently and urgently required data available in a cache, and offer the user an option to optimize the installed applications or operating systems by caching. In embodiments of the invention the system of the invention, once the user has selected a program for optimization, checks the size of the computer's RAM, and partitions a portion of the RAM as cache.

Referring again to FIG. 1, computer system 108 has connectivity to Internet 100 through a cable modem connection 102, an Internet Service Provider 107 and a network link 111. In this embodiment of the invention a cable modem connection is illustrated but there are many other ways the computer 108 may connect to Internet 100, such as dial-up access from a telephone line, through a Digital Subscriber Line (DSL) or any other possible ways offered by the service provider 107 to connect to the Internet 100, and therefore the connection system exemplified is not to be construed as a limitation to practicing the present invention. Computer 108 is represented in FIG. 1 by a desktop computer icon, however other network-capable, software-supporting appliances may practice the present invention without departing from its spirit and scope. Examples include application-hosting, platform software based cellular phones, mobile laptop personal computers or any other similarly adapted device that carries software applications and/or a software-based operating system.

In this example, access to SW 105 for download onto the computer 108 and utilizing dB 106, following purchase or gratuitous delivery, is achieved by transmittal from the HS 104 of the service provider 103 via network 100 and is website based. However, access to SW 105 and dB 106 may be achieved by other media such as, but not limited to, compact disc recording or wireless transmission without departing from the spirit and scope of the present invention, and should not be construed as a limitation to practicing the present invention.

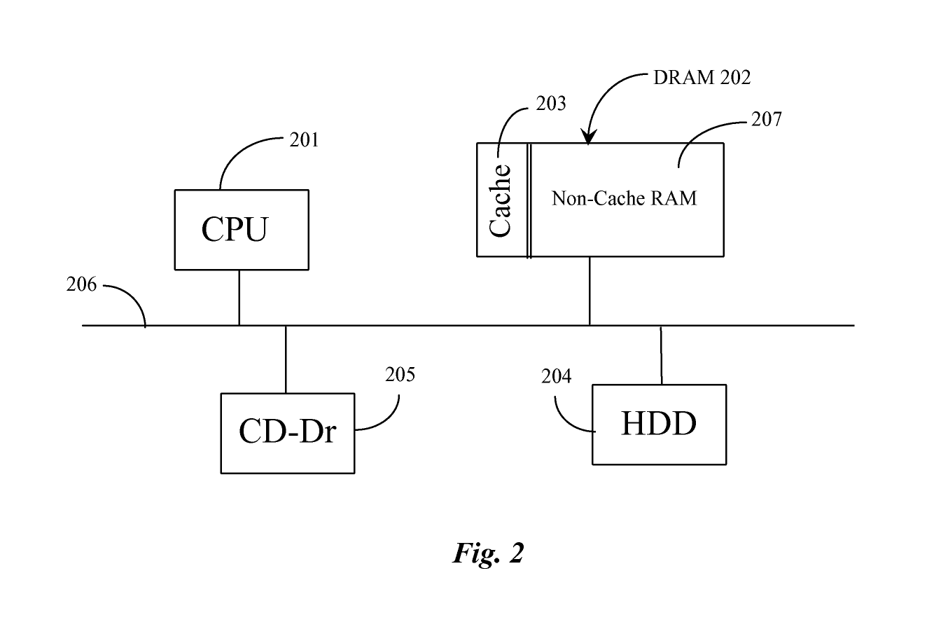

FIG. 2 is an architectural diagram illustrating elements of a general-purpose computer, including a CPU 201, a hard disk drive (HDD) 204, a CD drive 205 and an interconnecting bus 206. Bus 206 is representative of all the wires, cables and other hardware and appliances that connect the illustrated elements of the computer system to one another. DRAM 202 is shown partitioned into a cache portion 203 and a non-cache portion 207. In various embodiments of the invention cache 203 is configured to operate selectively with certain programs found to match programs in dB 106.

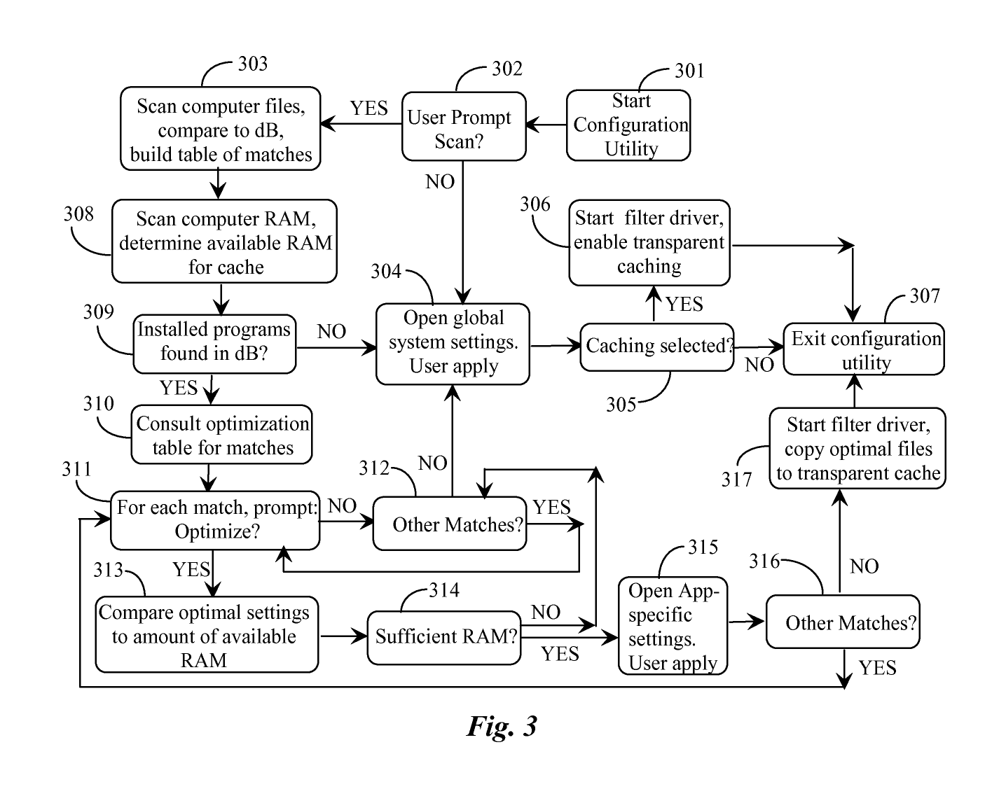

FIG. 3 is a process flowchart illustrating steps for configuring and utilizing the optimization of installed applications and operating systems on a computer system operated by the user according to an embodiment of the present invention.

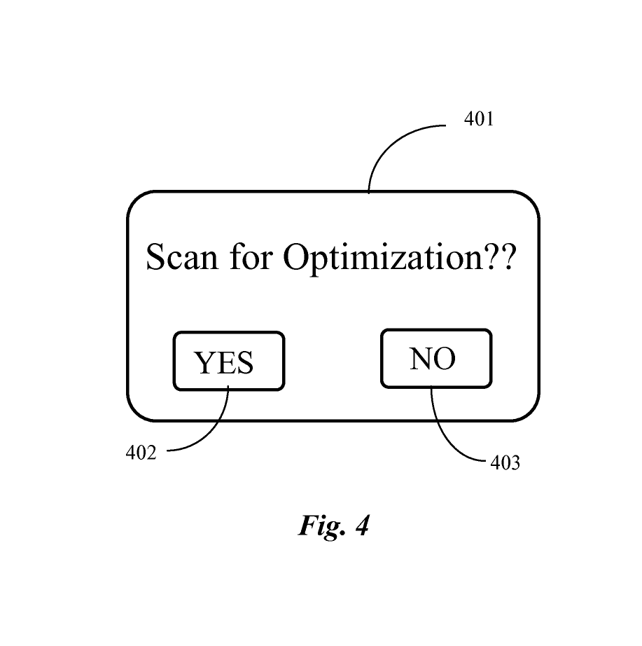

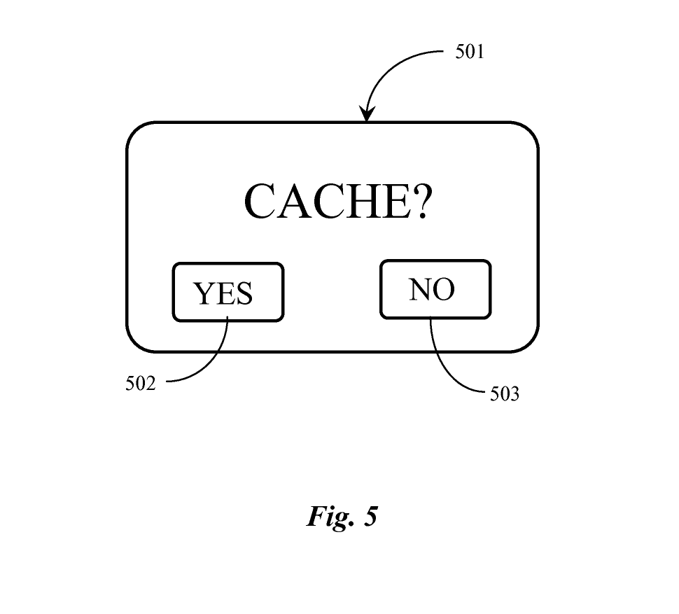

In practice according to one embodiment, the user may commence operating a computer system by applying power and attending to any start-up requirements such as password input, at which time a start configuration utility step 301 of the present invention may automatically commence operation. Step 301 may then cause a step 302 which is to initialize an on-screen interactive interface 401 (see FIG. 4) to enquire of the user of computer 108 if the user might choose to have the present invention scan the computer system for installed programs. The user may reply yes or no by buttons 402 or 403. In the event that the user replies yes, step 303 may commence to scan computer 108 for installed applications and operating systems, compare the results of the scan to dB 106 and build a table of matches. In the event that the user replies no, step 304 opens global system settings. On completion of step 304, a step 305 enquires of the user if caching is to be selected, which may be by an interactive interface 501 (see FIG. 5). Should the user reply affirmatively, then step 306 may initiate to start a filter driver and enable transparent caching. Once step 306 completes, step 307 exits the configuration utility and concludes the operation. Should the user reply negatively at step 305, then step 307 exits the configuration utility and concludes operation.

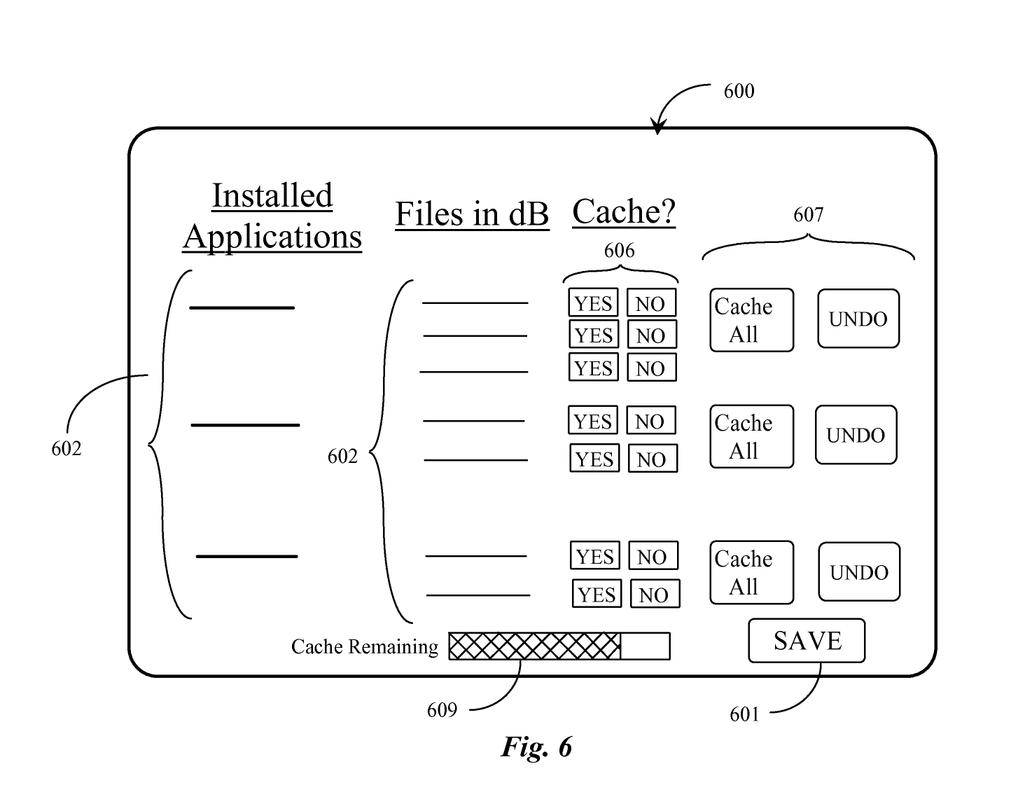

Referring again to step 303, once completed, control goes to step 308 which is to scan computer system 108 DRAM and determine the size of DRAM available for use as cache. If matches were found at step 303, at step 309 control goes to step 310. In the event matches were not found control goes to step 304 which proceeds as described above. In the event that matches were found at step 303, at step 309 control goes to step 310 which is to graphically display an optimization table illustrated in FIG. 6.

FIG. 6 is an illustration of an exemplary interactive interface 601 including the optimization table, which lists (602) the matches found in step 303, files available in dB 106, which is a list of appropriate optimization files 603, a series of interactive buttons 606 for selecting individual files to cache, a series of interactive buttons 607 labeled Cache All and Undo, enabling the user to generally cache all available files for each application or operating system, and to Undo Cache All, a bar gauge 609 showing available cache space remaining, and a button 601 enabling the user to save the settings. FIG. 6 is exemplary, and there are many ways in which the interface could be designed, and therefore this example should not be construed as a limitation to practicing the invention.

Returning to FIG. 3, step 311 prompts for the user to select or decline to optimize each of the indicated applications or operating systems by way of caching. This may be done by displaying a Y/N interactive choice to the user for each application or operating system in order, or through the interactive interface shown as FIG. 6. Should the user decline to optimize the first shown application step 312 looks for other matches and sends control back to step 311, which prompts the user for a decision for each, and provided there are no other matches, then control goes again to step 304, which sequences to step 307 as described above.

For each match the user selects to optimize at step 311 control goes to step 313, which compares the optimal settings to the amount of DRAM available for caching as discovered previously at step 308. Step 314 determines if sufficient DRAM space is available. In the event of a deficit of available DRAM, control returns to the step 312 and proceeds as described above. In the event DRAM is determined to be sufficient at step 315 the system looks for other matches at step 316, and control returns again to step 311. In the event that there are no more matches at step 316, step 317 starts a filter driver and copies the optimal files to the transparent cache. Following this, the invention may have completed its function and the configuration utility exits at step 307. There are many designs and process flow chart processes that could be used to practice the present invention, and therefore the designs and figures exemplified herein should not be construed as a limitation to practicing the present invention and other designs and flow chart processes might not depart from the spirit and scope of the present invention.

1. A method for optimizing performance of programs installed on a computing appliance, comprising steps of:
(a) scanning storage mechanisms of the computing appliance by executing a configuration utility by a Central Processing Unit (CPU) of the computing appliance to find and identify installed programs;
(b) comparing the determined installed programs to a database (dB) of information and files prepared to optimize performance of specific programs through caching, and determining matches between the installed programs and specific programs having information and files in the dB;
(c) among the matches found in step (b), selecting installed programs to optimize for performance;
(d) partitioning a portion of system RAM of the computing appliance as cache; and
(e) loading information and files from local storage mechanisms for each program selected in step (c) to the cache partitioned in system RAM, enabling the programs selected in step (c) to at least read data in operation from the cache portion partitioned in system RAM.

2. The method of claim 1 wherein the dB is referenced over the Internet network from an Internet connected server.

3. The method of claim 1 wherein the configuration utility and the dB are loaded to the computing appliance and referenced locally.

4. The method of claim 1 wherein, for program matches from step (b), in step (c) a user is presented an interactive interface with interactive indicia to configure the computing appliance for optimization of matching programs.

5. A system for optimizing performance of programs installed on a computing appliance, comprising:
a configuration utility executable on a CPU of the computing appliance from a non-transitory storage medium; and
a dB comprising information and files associated with programs, the information and files useful with cache operations to optimize performance of the programs;
wherein the configuration utility, executing on the CPU scans storage mechanisms of the computing appliance to find and identify installed programs, compares the determined installed programs to the database (dB) of information and files, and determines matches between the installed programs and specific programs having information and files in the dB, presents the matches to a user to select installed programs to optimize for performance, partitions a portion of system RAM of the computing appliance as cache, and loads information and files from the local storage mechanisms for each program selected to the cache partitioned in system RAM, enabling the programs selected to at least read data in operation from the cache portion partitioned in system RAM.

6. The system of claim 5 wherein the the dB is referenced over the Internet network from an Internet connected server.

7. The system of claim 5 wherein the configuration utility and the dB are loaded to the computing appliance and referenced locally.

8. The system of claim 5 wherein, for program matches a user is presented an interactive interface with interactive indicia to configure the computing appliance for optimization of matching programs.

9. An internet connected server comprising:
software executing from a non-transitory medium;
a configuration utility executable on a CPU of a computing appliance; and
a stored dB comprising information and files associated with programs prepared to optimize performance of specific programs in caching operation;
wherein the server provides an interactive interface to a browser executing on an Internet connected computing appliance, the interactive interface enabling a user to download the dB and the configuration utility, to be executed on the CPU of the computing appliance, identifying programs installed on the computing appliance that may be optimized by information and files from the dB, partitioning a portion of system RAM of the computing appliance as cache, and loading information and files from the local storage mechanisms to the cache portion of system RAM, optimizing performance of the programs identified on the computing appliance.
